(19) United States
(12) Patent Application Publication
(10) Pub. No.: US 2010/0085174 A1
(43) Pub. Date: Apr. 8, 2010

(54) MONITORING SYSTEM FOR A VEHICLE

(75) Inventor: Ci Kun QUAN, Kowloon (HK)

Correspondence Address: WILLIAM J. SAPONE;COLEMAN SUDOL SAPONE P.C., 714 COLORADO AVENUE, BRIDGE PORT, CT, 06605, US

(73) Assignee: Tsuen Shing Enterprises Limited, Kowloon (HK)

(21) Appl. No.: 12/244,806

(22) Filed: Oct. 3, 2008

(51) Int. Cl. B60Q 1/00

(52) U.S. Cl. 340/438

(57) ABSTRACT

A monitoring system for a car (10) having a top (12) movable along a path of movement is disclosed as including a number of pairs of infrared (IR) transmitters (22a, 22b) and infrared (IR) receivers (24a, 24b), in which each IR receiver is adapted to receive IR signals transmitted by a respective IR transmitter, and output means (52), in which the IR transmitters and IR receivers are positioned on each side of the path of movement of the top, and, in operation, the output means is adapted to produce an audio and/or visual output if at least one of the IR receivers receives no IR signals from the respective IR transmitter.

This invention relates to a monitoring system for a vehicle, and in particular such a system for monitoring if the path of movement of a movable part of said vehicle is free of any obstacle.

### BACKGROUND OF THE INVENTION

Some vehicles have movable parts which are exposed to the outside environment, e.g. a movable roof, whose closing and opening movement are powered by a motor in the vehicles and may be controlled by a driver. When a driver is driving the vehicle, if he/she would like to close a roof which is originally open, he/she may press a button to activate a motor to close the roof. However, there is in existence no system for monitoring whether the path of movement of the roof is free of obstacle. If, for example, the vehicle carries articles, e.g. ski boards, which extend above the roof level, closing the roof may damage the articles, which may cause distraction to the driver, affecting the safety of driving.

It is thus an object of the present invention to provide a monitoring system for a vehicle in which the aforesaid shortcomings are mitigated, or at least to provide a useful alternative to the public.

### SUMMARY OF THE INVENTION

According to the present invention, there is provided a monitoring system for a vehicle, said vehicle having at least one part movable along a path of movement, said system including at least one infrared transmitter, at least one infrared receiver adapted to receive infrared signals transmitted by said infrared transmitter, and output means, wherein said infrared transmitter and said infrared receiver are positioned one on each side of said path of movement of said movable part, and wherein, in operation, said output means is adapted to produce an output in response to said at least one infrared receiver receiving no infrared signals from said at least one infrared transmitter.

Advantageously, the system may include a plurality of pairs of infrared transmitters and infrared receivers.

Preferably, at least two of said infrared transmitter may be connected to a control unit in series.

Suitably, at least two of said of infrared transmitters may be connected to a control unit in parallel.

In operation, said output means may be advantageously adapted to produce an output in response to at least one of said infrared receivers receiving no infrared signals from its corresponding infrared transmitter.

Advantageously, said plurality of infrared transmitters may be mounted on a first panel and said plurality of infrared receivers may be mounted on a second panel.

The movable part may suitably be a movable roof, collapsible top, tail box or sunroof of a motor car.

### BRIEF DESCRIPTION OF THE DRAWINGS

A monitoring system for a vehicle according to a preferred embodiment of the present invention will now be described, by way of an example only, with reference to the accompanying drawings, in which:

FIG. 1 shows a car installed with a monitoring system for a vehicle according to a preferred embodiment of the present invention;

FIG. 2 shows arrangement of a number of infrared (IR) transmitters and a number of infrared (IR) receivers in the system shown in FIG. 1;

FIG. 3 shows a cross-sectional view taken along the line A-A in FIG. 2;

FIG. 4 shows a first manner of connecting the IR transmitters and IR receivers with a control unit; and

FIG. 5 shows a second manner of connecting the IR transmitters and IR receivers with a control unit.

### DETAILED DESCRIPTION OF THE PREFERRED EMBODIMENT

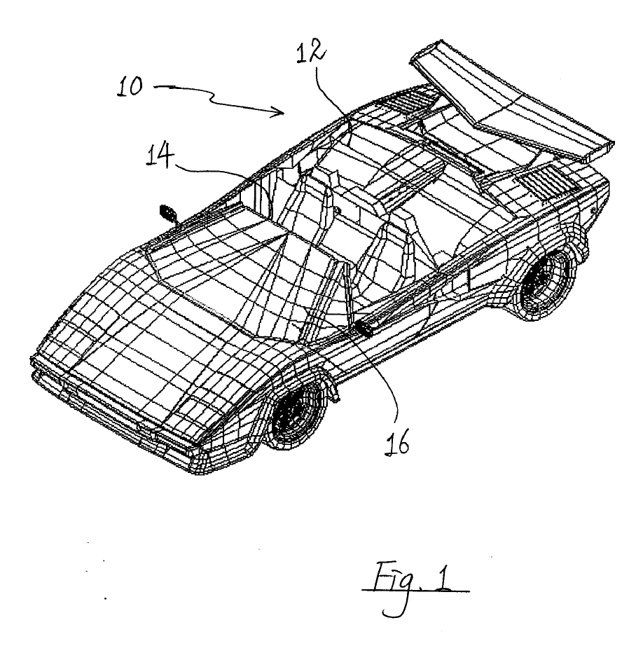

FIG. 1 shows a motor car (i.e. a land vehicle), generally designated as 10, installed with a monitoring system for a vehicle according to a preferred embodiment of the present invention The car 10 has a top 12 which is movable between a closed position in which a free end of the top 12 abuts a free edge 14 of a windscreen 16 and an open position in which the free end of the top 12 is out of contact with the free edge 14 of the windscreen 16.

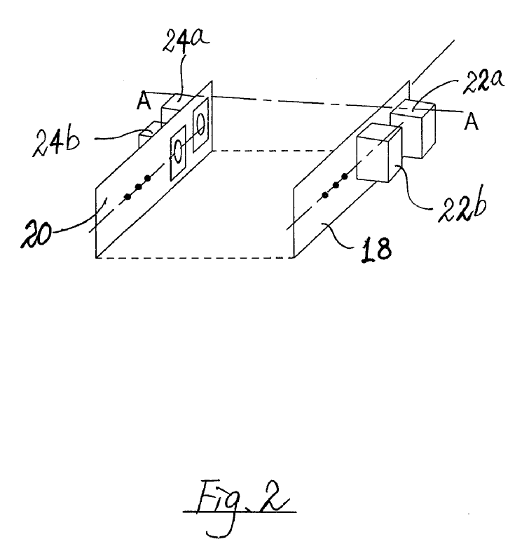

As shown in FIG. 2, on each side of the path of movement of the top 12 is installed a respective panel 18, 20. To the panel 18 are installed a number of infrared (IR) transmitters 22a, 22b, . . . , and to the panel 20 are installed a number of infrared (IR) receivers 24a, 24b, . . . , such that a number of IR transmitter-receiver pairs 22a, 24a; 22b, 24b; . . . are formed. The IR transmitter-receiver pair 22a, 24a are positioned such that, in the absence of any obstruction therebetween, the IR receiver 24a can receive IR signals transmitted by the IR transmitter 22a; and similarly, the IR signal transmitter-receiver pair 22b, 24b are positioned such that, in the absence of any obstruction therebetween, the IR receiver 24b can receive IR signals transmitted by the IR transmitter 22b. The area between the panels 18, 20 is thus monitored by the IR transmitter-receiver pairs 22a, 24a; 22b, 24b; . . . .

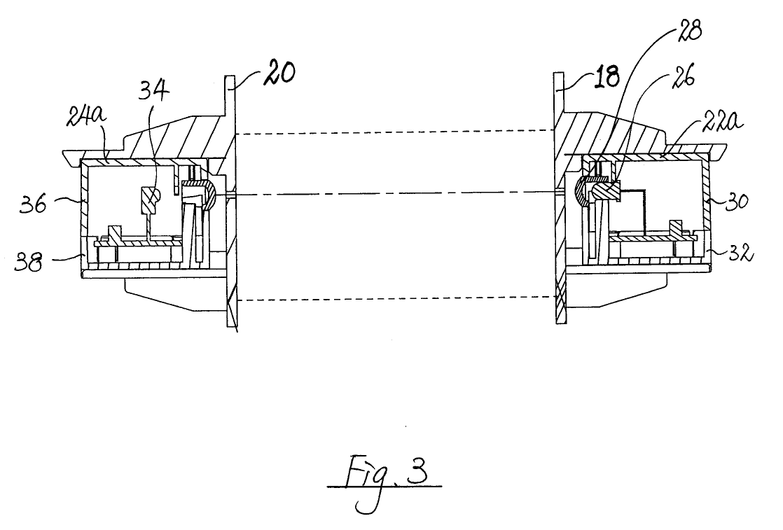

As shown more clearly in FIG. 3, the IR transmitter 22a includes an IR transmitting unit 26 positioned adjacent a piece of lens 28 through which IR signals transmitted by the IR transmitting unit 26 may pass. The IR transmitting unit 26 is enclosed by a top cover 30 and a bottom cover 32. As to the IR receiver 24a, such includes an IR receiving unit 34 for detecting IR signals. The IR receiver 24a is also enclosed by a top cover 36 and a bottom cover 38. There is a straight line-of-sight between the IR transmitting unit 26 and the IR receiving unit 34.

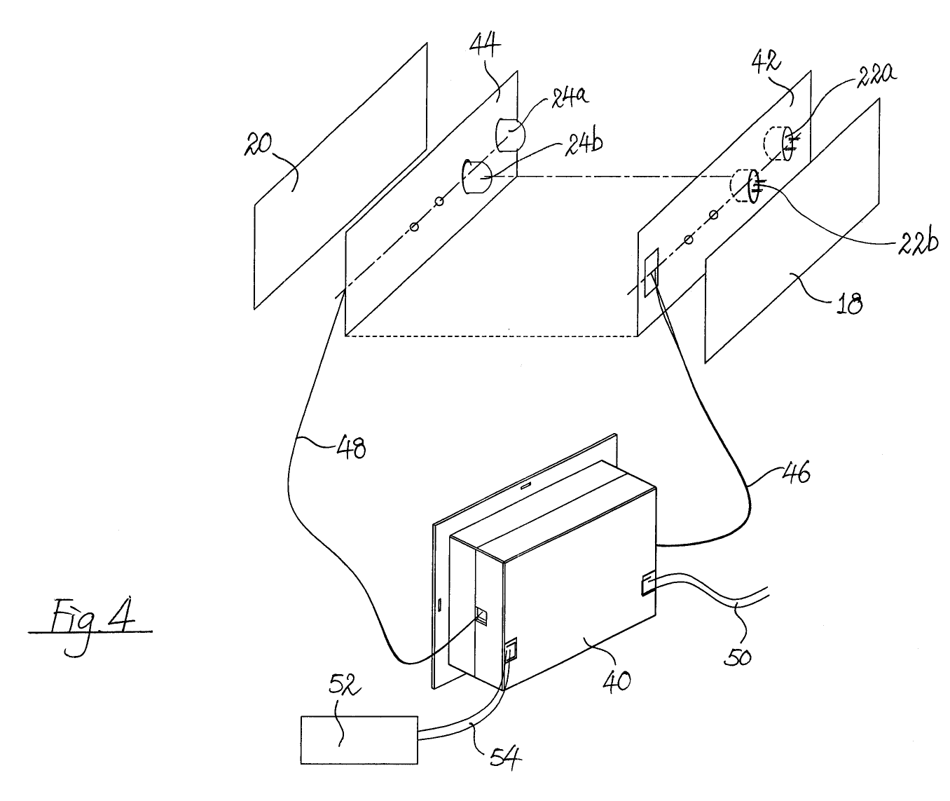

Turning to FIG. 4, such shows a first way of connecting the IR transmitters 22a, 22b, . . . and IR receivers 24a, 24b, . . . with a control unit 40. The IR transmitters 22a, 22b, . . . are installed on a printed circuit board (PCB) 42, which is in turn secured to the panel 18. The IR receivers 24a, 24b, . . . are installed on a printed circuit board (PCB) 44, which is in turn secured to the panel 20. Signals from the PCB 42 are transmitted to the control unit 40 by an electric wire 46, and signals from the PCB 44 are transmitted to the control unit 40 by an electric wire 48. The control unit 40 is powered by the car 10 via an electric cable 50, and control signals from the control unit 40 are transmitted to an output means 52 via an electric wire 54.

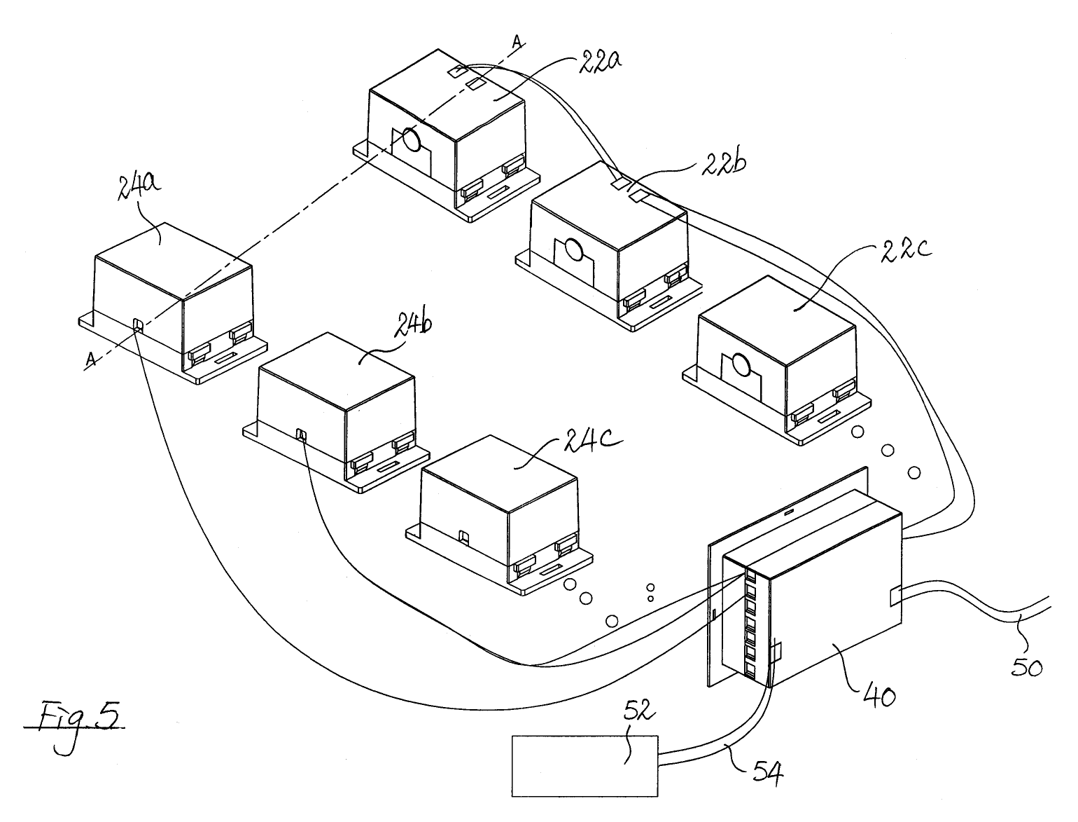

FIG. 5 shows alternative way of connecting the IR transmitter 22a, 22b, . . . and IR receivers 24a, 24b, . . . with the control unit 40. In this arrangement, the IR transmitters 22a, 22b, 22c, . . . are connected with the control unit 40 in series, whereas the IR receivers 24a, 24b, 24c . . . are connected with the control unit 40 in parallel.

In use, if the movable top 12 is in the open position, a driver may press a button, e.g. on a centre console of the car 10, to activate a motor (not shown) in the car to move the top 12 to the closed position. If nothing obstructs the path of movement of the top 12, the relevant IR receivers 24a, 24b, . . . should all receive IR signals transmitted by the respective corresponding IR transmitters 22a, 2213, . . . . However, if at least one of IR receivers 24a, 24b, does not receive any IR signals transmitted by its corresponding IR transmitter 22a, 22b, . . . , it means that there is obstruction along at least part of the path of movement of the top 12. In this case, the control unit 40 will receive signals (or will receive no signals) from the relevant IR receiver, which signifies that the relevant IR receiver does not receive any IR signals from its corresponding IR transmitter, whereupon the control unit 40 will output signals to prevent operation of the motor and thus to prevent any closing movement of the top 12, even if the driver presses the relevant button hoping to close the top 12. In addition, the control unit 40 will instruct the output means 52 to issue output (e.g. turn on a light, and/or issue an audible alarm, etc.) to warn the driver of the situation.

When the obstruction between the relevant IR transmitter-receiver pair is removed, all relevant IR receivers 24a, 24b, . . . receive IR signals transmitted by the respective corresponding IR transmitters 22a, 22b, . . . . In such a case, if the driver again presses the button to activate the top 12, the top 12 will move to the close position.

The present invention may be installed in a convertible type car for monitoring the opening and/or closing of a collapsible top, or in a motor car for monitoring the opening and/or closing of a sunroof or a tail box. The IR transmitter-receiver pairs 22a, 24a; 22b, 24b; . . . may be installed on the same level as, or slightly below, the path of movement of the top 12.

It should be understood that the above only illustrates an example whereby the present invention may be carried out, and that various modifications and/car alterations may be made thereto without departing from the spirit of the invention. It should also be understood that various features of the invention which are, for brevity, described here in the context of a single embodiment, may be provided separately or in any appropriate sub-combinations.

1. A monitoring system for a vehicle, said vehicle having at least one part movable along a path of movement, said system including:
at least one infrared transmitter;
at least one infrared receiver adapted to receive infrared signals transmitted by said infrared transmitter; and
output means;
wherein said infrared transmitter and said infrared receiver are positioned one on each side of said path of movement of said movable part; and
wherein, in operation, said output means is adapted to produce an output in response to said at least one infrared receiver receiving no infrared signals from said at least one infrared transmitter.

2. A system according to claim 1 including a plurality of pairs of infrared transmitters and infrared receivers.

3. A system according to claim 2 wherein at least two of said infrared transmitters are connected to a control unit in series.

4. A system according to claim 2 wherein at least two of said of infrared transmitters are connected to a control unit in parallel.

5. A system according to claim 2, wherein, in operation, said output means is adapted to produce an output in response to at least one of said infrared receivers receiving no infrared signals from its corresponding infrared transmitter.

6. A system according to claim 2 wherein said plurality of infrared transmitters are mounted on a first panel and said plurality of infrared receivers are mounted on a second panel.

7. A system according to claim 1 wherein said movable part is a movable roof, collapsible top, tail box or sunroof of a motor car.

8. A system according to claim 1 wherein said output means is adapted to issue audio and/or visual output.

9. A system according to claim 3 wherein, in operation, said output means is adapted to produce an output in response to at least one of said infrared receivers receiving no infrared signals from its corresponding infrared transmitter.

10. A system according to claim 4 wherein, in operation, said output means is adapted to produce an output in response to at least one of said infrared receivers receiving no infrared signals from its corresponding infrared transmitter.

11. A system according to claim 3 wherein said plurality of infrared transmitters are mounted on a first panel and said plurality of infrared receivers are mounted on a second panel.
